(19) United States
(12) Patent Application Publication
(10) Pub. No.: US 2013/0076942 A1
(43) Pub. Date: Mar. 28, 2013

(54) IMAGE TAKING APPARATUS

(71) Applicant: Yukinori Azuma, Izumi-shi (JP)

(72) Inventor: Yukinori Azuma, Izumi-shi (JP)

(73) Assignee: SANYO ELECTRIC CO., LTD., Osaka (JP)

(21) Appl. No.: 13/599,366

(22) Filed: Aug. 30, 2012

(30) Foreign Application Priority Data
Sep. 28, 2011 (JP) 2011-211827

(51) Int. Cl. H04N 5/76

(52) U.S. Cl. 348/231.99; 348/E05.031

(57) ABSTRACT

An image taking apparatus according to the present invention includes: an image pickup unit; a memory that stores an image taken by the image pickup unit as image data; a control circuit; and an operation unit for giving a command to the control circuit. The control circuit includes: a mark registration unit that registers an image taken by the image pickup unit as a mark image in the memory depending on a mark registration command; an image cutting unit that determines a polygonal region having display positions of a plurality of mark images as a plurality of apexes by using an image taken by the image pickup unit as a target depending on an image cutting command, and cuts the polygonal region out of the image taken by the image pickup unit; and a cut-out image recording unit that records the image cut out by the image cutting unit.

### CROSS-REFERENCE TO RELATED APPLICATIONS

This application is based on Japanese Patent Application No. 2011-211827, the entirety of which is incorporated herein by reference.

### BACKGROUND OF THE INVENTION

1. Field of the Invention

The present invention relates to an image taking apparatus that can take an image by an image pickup unit and write the taken image in a memory.

2. Description of Related Art

In order to keep a text written on a white board as a record in a meeting, for example, the white board is photographed with a digital camera, and the taken image is recorded as a memo or is output with a printer.

In this case, since the image taken by the digital camera includes not only an image part desired to be kept as a record but also an image part not necessary as the record, a process is performed in which only a necessary image part is cut out by using an image trimming function of the digital camera or a personal computer.

However, in a digital camera including the image trimming function, when a necessary image part is cut out from a taken image, a user must perform an operation of setting a position and a size of a trimming frame on a screen, and this operation is disadvantageously cumbersome.

### SUMMARY OF THE INVENTION

An image taking apparatus according to the present invention includes: an image pickup unit; a memory that stores an image taken by the image pickup unit as image data; a control circuit; and an operation unit configured to give a command to the control circuit.

The control circuit includes a mark registration unit that registers an image taken by the image pickup unit as a mark image in the memory depending on a mark registration command obtained by an operation of the operation unit, an image cutting unit that determines a polygonal region having display positions of a plurality of mark images as a plurality of apexes by using an image taken by the image pickup unit as a target depending on an image cutting command obtained by an operation of the operation unit, and cuts the polygonal region out of the image taken by the image pickup unit, and a cut-out image recording unit that records the image cut out by the image cutting unit.

### BRIEF DESCRIPTION OF THE DRAWINGS

FIG. 1 is a block diagram showing a configuration of a digital camera according to one embodiment of the present invention;

FIG. 2 is a diagram showing a plurality of examples of marks written by hand;

FIG. 3 is a flow chart showing a mark image registration process;

FIG. 4 is a flow chart showing an image recording process using a mark image;

FIG. 5 is a diagram illustrating a character group written on a white board; and

FIG. 6 is a diagram showing an image part cutout by a mark image.

### DETAILED DESCRIPTION OF THE PREFERRED EMBODIMENT

Embodiments in which the present invention is carried out to the digital camera will be specifically described below with reference to the drawings.

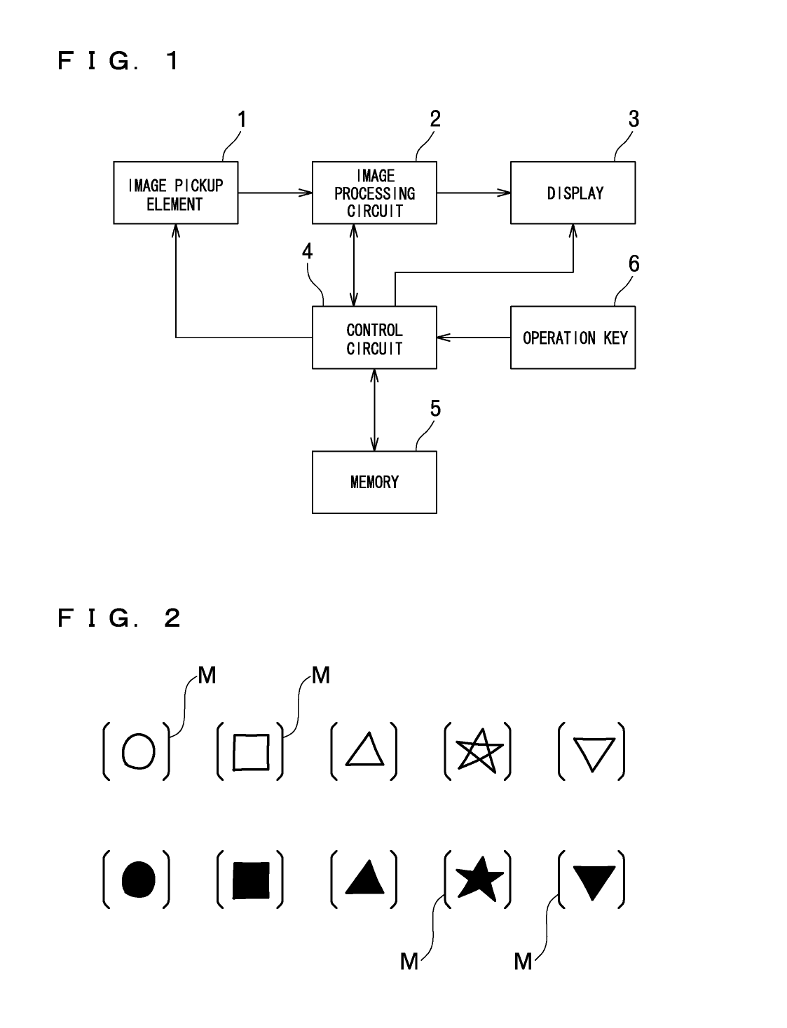

A digital camera according to one embodiment of the present invention, as shown in FIG. 1, includes an image pickup element 1 configured by a CCD, an image processing circuit 2 that performs a necessary process such as AD conversion to an image signal obtained by the image pickup element 1, a display 3 that displays an image based on an image signal obtained from the image pickup element 1, a memory 5 configured to store an image data obtained from the image processing circuit 2, a control circuit 4 such as a CPU that controls writing and reading of the image data for the image pickup element 1, the image processing circuit 2, and the memory 5, and an operation key 6 configured to give various commands to the control circuit 4.

The operation key 6 includes a shutter key.

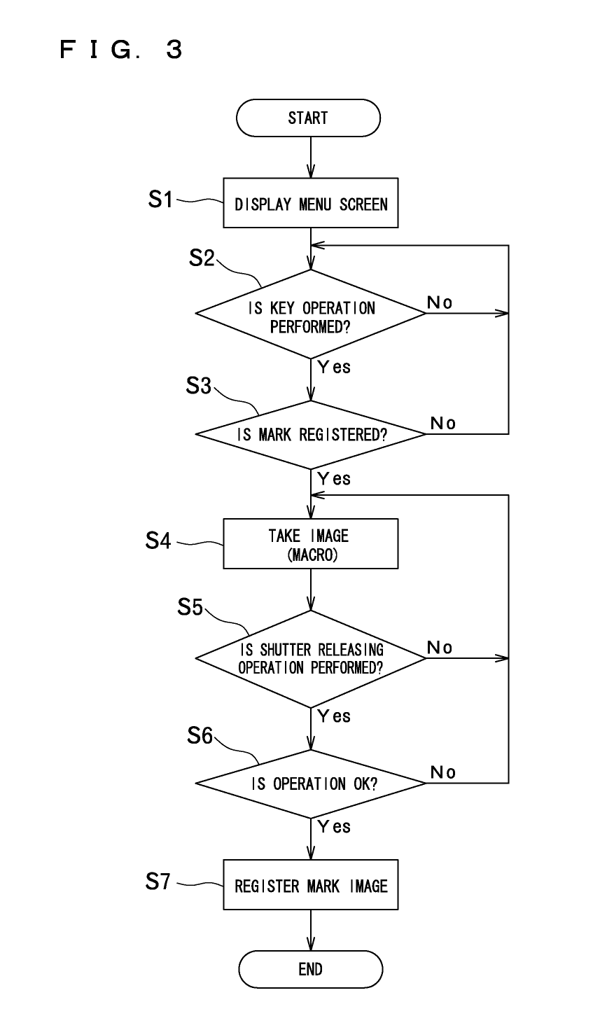

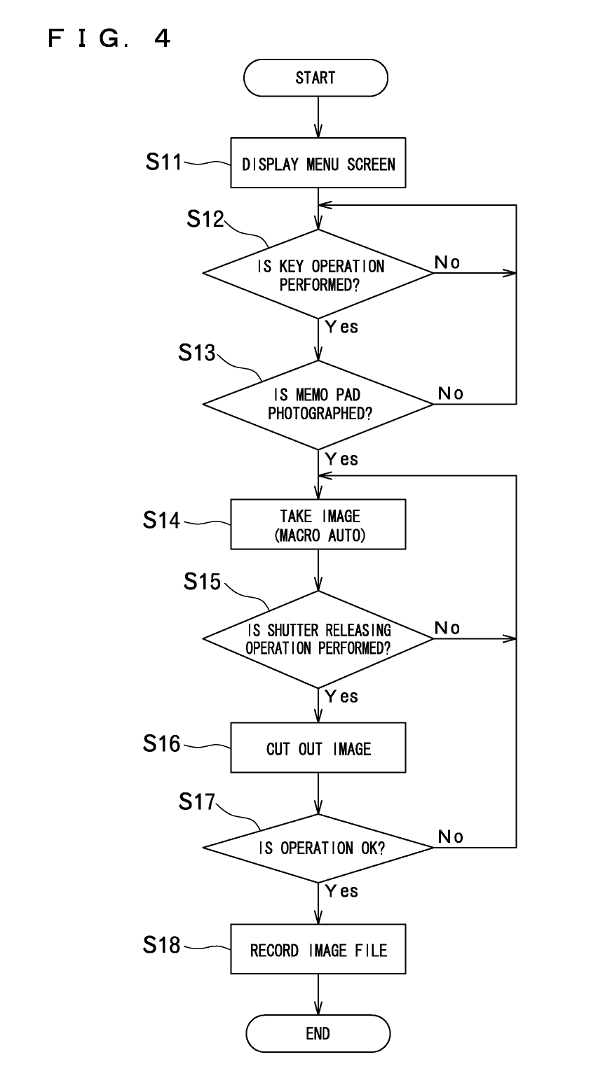

The control circuit 4 executes a mark image registration process shown in FIG. 3 and an image recording process shown in FIG. 4. More specifically, the CPU executes a program stored in the flash memory (not shown) to realize the process.

The mark image registration process shown in FIG. 3 is a process that is performed as preparation when only a necessary character group is cut out of a character string, a sign, a graph, and the like (hereinafter, referred to as a character group) written on a white board or a paper surface and recorded. On the paper surface, a user writes a desired mark in advance by hand. As the mark, as shown in FIG. 2 for example, a mark M, which can be discriminated from a letter and which image can be easily recognized by a digital camera, is desirably used.

In step S1 in FIG. 3, a menu screen is displayed on the display 3. In step S2, it is determined whether any key operation is performed by a user operating the operation key 6 on the menu screen. When any key operation is performed in step S2, it is determined as YES to shift to step S3, and it is determined whether “mark registration” is selected by the key operation.

When the user selects the “mark registration” by operating the operation key 6, it is determined as YES in step S3 to shift to step S4. In step S4, a mark written on the paper surface in advance is photographed in a macro photographing mode. In the macro photographing mode, a minimum photographing distance is shorter than that in an auto-focus mode. Even though the device is close to an object to be photographed, an in-focus photographic image can be obtained. The photographic image, i.e., a mark image showing a mark is displayed on the display 3.

When it is determined as YES in step S2 and step S3, the process returns to step S2.

Thereafter, in step S5, it is determined whether a shutter release operation is performed. When the user operates a shutter key, it is determined as YES, and the process shifts to step S6. In step S6, it is determined whether it is OK to register the mark image displayed on the display 3 at that time as the mark M.

When the user operates the operation key 6 to select “OK”, the process shifts to step S7, and the mark image displayed on the display 3 at that time is registered as the mark M in the memory, and the process is ended.

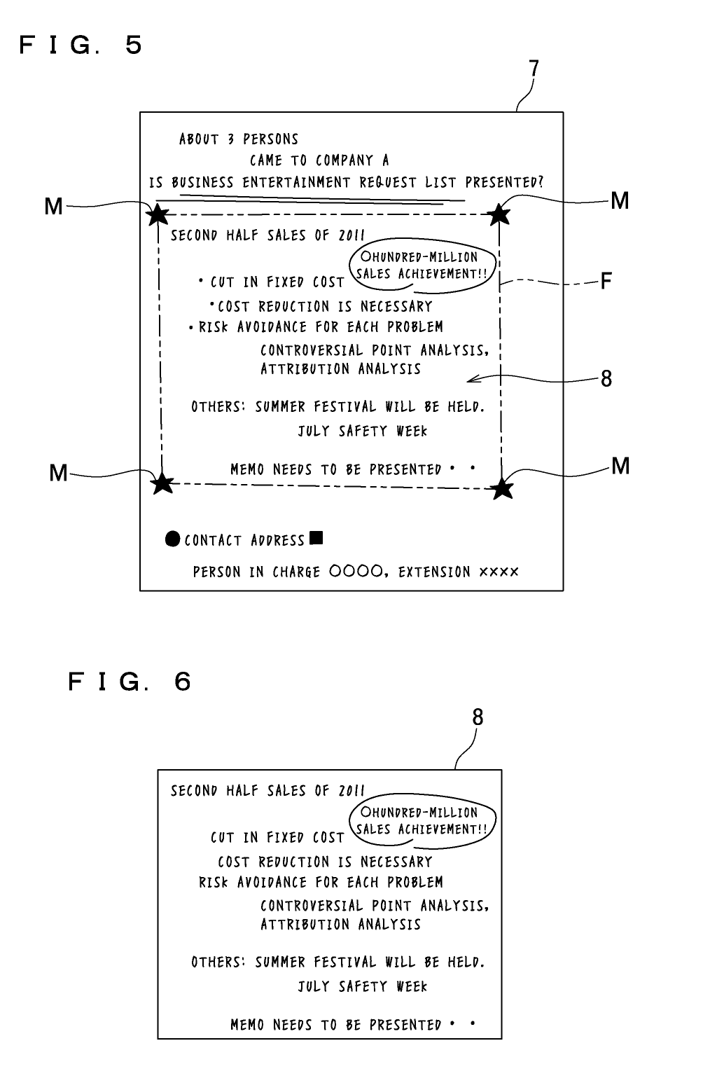

The image recording process shown in FIG. 4 is a process that records only a necessary character group of character groups written on a white board or a paper surface by using the mark M registered by the mark image registration process. For example, to a character group written on a white board 7, as shown in FIG. 5, the user assumes a square cut frame F surrounding a character group desired to be kept as a record, writes the marks M at apex positions of the cut frame F by hand, and then instructs execution of the image recording process.

First, in step S11 in FIG. 4, a menu screen is displayed on the display 3. In step S12, it is determined whether any key operation is performed on the menu screen. Furthermore, in step S13, when any key operation is performed, it is determined whether “memo pad photographing” is selected by the key operation.

When the user selects the “memo pad photographing” by operating the operation key 6, it is determined as YES in step S13 to shift to step S14. When it is determined as NO in step S12 and step S13, the process returns to step S12.

In step S14, the macro photographing mode or the auto-focus mode is set depending on a distance to an object to be photographed (for example, a paper surface or a white board) to photograph the object to be photographed. The photographic image is displayed on the display 3.

Thereafter, in step S15, it is determined whether a shutter release operation is performed. When the user operates the shutter key, it is determined as YES, and the process shifts to step S16. In step S16, the registered mark M is read from the memory 5, and the mark M is searched from the photographic image by pattern matching. At this time, when the user photographs the white board 7 in FIG. 5, for example, the four marks M are detected. By using a square including the positions of the four marks M as four apexes as a cut-out frame F, an image part 8 surrounded by the cut-out frame F is cut out from the photographic image (FIG. 6). The cut-out image part 8 is displayed on the display 3 as a cut-out image.

Furthermore, in step S17 in FIG. 4, it is determined whether it is OK to register the cut-out image displayed on the display 3 at that time.

When the user operates the operation key to select “OK”, it is determined as YES in step S17, the process shifts to step S18 to file and record the image displayed on the display at that time in the memory 5, and the process is ended.

Upon the filing of the image, the control circuit 4 controls JPEG codec or the like (not shown) to perform a compression process or the like and records the file in the memory 5 in a predetermined file format.

When it is determined as NO in step S15 and step S17, the process returns to step S14.

As described above, when, by using the digital camera according to the embodiment, a necessary character group is cut out from a character string, a sign, a graph, and the like written on, e.g., a white board or a paper surface and recorded, the next mark registration process is performed as the preparation.

First, a mark to be registered is written on the white board or the paper surface. The mark can be written by the user writing a desired mark by hand. The writing of the mark can also be performed by the user attaching a sticker prepared in advance.

The mark is photographed with a photographing element, and the operation unit is operated to instruct registration of the mark. In response to this, the image of the photographed mark is registered in the memory 5.

Thereafter, when a necessary region in which a character group is written on, e.g., a white board or a paper surface is recorded, marks are written at the apex positions of the cut-out frame to cut out the necessary region by the same method as that used in the mark registration, for example, hand writing.

When the character group written on the white board or the paper surface is being photographed, the operation key is operated to instruct cutting out of an image. According to this, by using the image taken by the photographing element as a target, the mark images registered in the memory 5 are searched.

As a result, a plurality of mark images are searched, a polygonal region including display positions of the plurality of searched mark image as a plurality of apexes is determined, and the polygonal region is cut out of the image taken by the image pickup element.

The cut-out image is stored in the memory 5 or printed on the paper surface.

According to the digital camera, a desired image part can be easily cut out and recorded without causing the user to set a trimming frame on the screen. More specifically, by merely writing the four marks M directly written on a white board or a paper surface on which a character group is written, the desired image part 8 can be easily cut out and recorded.

A configuration of the components of the present invention is not limited to the above embodiment. A person skilled in the art can variously modify the invention without departing from the spirit and scope of the invention described in the claims . For example, the image part 8 as shown in FIG. 6 can be recorded in the memory 5 or can also be printed by a printer (not shown) connected to the control circuit 4 in FIG. 1 without being recorded in the memory 5.

The mark M is not limited to those shown in FIG. 2, and various marks can be employed. Furthermore, the writing of the mark can also be performed by attaching to the white board a sticker printed with a mark.

The square cut-out frame F defined by the four marks M surrounding a character group to be cut out includes a rectangle, a rhombus, a parallelogram, and the like. The number of marks M to be written on the white board is not limited to 4, and may be set to 3 or 5 or more. When three marks M are used, a rectangle having the three mark positions as three apexes is set as the cut-out frame. When five or more marks M are used, a polygon having five or more corners is set.

A configuration can be employed in which a plurality of cut-out frames are set by a plurality of marks and a plurality of cut-out images are recorded as independent files or a configuration in which various types of marks are set to classify the cut-out images depending on the types of marks.

In the embodiment, a program which is configured to execute the processes shown in FIG. 3 and FIG. 4 is stored in a flash memory in advance. However, the processes may be executed by downloading the program from the outside.

In the embodiment, the cut-out image part 8 is displayed on the display 3 as the cut-out image. When “OK” is selected for registration of this cut-out image, the image part 8 is recorded in the memory 5. However, the image part 8 may be automatically recorded in the memory 5. When the shutter key is operated, the photographic image is recorded in the memory 5, and the control circuit 4 may read the photographic image from the memory 5 to cutout the image part 8 based on the detection of the mark M.

A touch panel may be installed on the surface of the display 3 to configure the operation key. In this case, in the mark image registration process, a desired mark image for the image taken in the auto-focus mode may be touched to register the mark image.

What is claimed is:

1. An image taking apparatus comprising:
an image pickup unit;
a memory that stores an image taken by the image pickup unit as image data;
a control circuit; and
an operation unit configured to give a command to the control circuit, wherein
the control circuit includes:
a mark registration unit that registers the image taken by the image pickup unit as a mark image in the memory depending on a mark registration command obtained by an operation of the operation unit;
an image cutting unit that determines a polygonal region having display positions of a plurality of mark images as a plurality of apexes by using an image taken by the image pickup unit as a target depending on an image cutting command obtained by an operation of the operation unit, and cuts the polygonal region out of the image taken by the image pickup unit; and
a cut-out image recording unit that records the image cut out by the image cutting unit.

2. The image taking apparatus according to claim 1, wherein the polygonal region is a rectangle having four apexes.

3. The image taking apparatus according to claim 1, wherein the cut-out image recording unit stores the cut-out image in the memory.

4. The image taking apparatus according to claim 2, wherein the cut-out image recording unit stores the cut-out image in the memory.

5. The image taking apparatus according to claim 1, wherein the cut-out image recording unit prints the cut-out image on a paper surface.

6. The image taking apparatus according to claim 2, wherein the cut-out image recording unit prints the cut-out image on a paper surface.

7. The image taking apparatus according to claim 1, further comprising a display that displays the image taken by the image pickup unit, wherein
the mark image taken by the image pickup unit is displayed on the display, depending on the mark registration command obtained by the operation of the operation unit.

8. The image taking apparatus according to claim 2, further comprising a display that displays the image taken by the image pickup unit, wherein
the mark image taken by the image pickup unit is displayed on the display, depending on the mark registration command obtained by the operation of the operation unit.

9. The image taking apparatus according to claim 3, further comprising a display that displays the image taken by the image pickup unit, wherein
the mark image taken by the image pickup unit is displayed on the display, depending on the mark registration command obtained by the operation of the operation unit.

10. The image taking apparatus according to claim 4, further comprising a display that displays the image taken by
the image pickup unit, wherein the mark image taken by the image pickup unit is displayed on the display, depending on the mark registration command obtained by the operation of the operation unit.

11. The image taking apparatus according to claim 5, further comprising a display that displays the image taken by the image pickup unit, wherein
the mark image taken by the image pickup unit is displayed on the display, depending on the mark registration command obtained by the operation of the operation unit.

12. The image taking apparatus according to claim 6, further comprising a display that displays the image taken by the image pickup unit, wherein
the mark image taken by the image pickup unit is displayed on the display, depending on the mark registration command obtained by the operation of the operation unit.
